(19) United States
(12) Patent Application Publication
(10) Pub. No.: US 2026/0049825 A1
(43) Pub. Date: Feb. 19, 2026

(54) METHOD FOR REQUESTING USE OF A POINT OF INTEREST USING PREDICTION OF WAITING TIME AND DEVICE FOR IMPLEMENTING THE SAME

(71) Applicants: Hyundai Motor Company, Seoul (KR); Kia Corporation, Seoul (KR)

(72) Inventor: Hyun Soo Kim, Hwaseong (KR)

(21) Appl. No.: 19/292,662

(22) Filed: Aug. 6, 2025

(30) Foreign Application Priority Data
Aug. 13, 2024 (KR) 10-2024-0108108

(51) Int. Cl. G01C 21/34; G01C 21/36

(52) U.S. Cl. CPC G01C 21/3476; G01C 21/3679; G01C 21/3691

(57) ABSTRACT

Disclosed herein a method for requesting use of a point of interest using prediction of waiting time and device for implementing the same. The method includes, using an electronic device, comprising a processor and a memory, generating an expected arrival time for a destination designated by a user in response to determining that the destination is a spot available for a request, estimating a waiting time for using the destination based on waiting information comprising a waiting-for-use pattern of the spot; estimating an expected time of use for the spot based on the waiting time of the spot, requesting use of the spot to generate a request for use in response to the expected arrival time being the expected time of use or earlier, and providing a route to the spot in response to an approval for the request of use.

### CROSS-REFERENCE TO RELATED APPLICATION

This application claims, under 35 U.S.C. § 119 (a), the benefit of Korean Patent Application No. 10-2024-0108108, filed on Aug. 13, 2024, in the Korean Intellectual Property Office, the entire contents of which are incorporated herein by reference.

### BACKGROUND

### (a) Technical Field

The present disclosure relates to a method of requesting use of a point of interest (POI) using waiting time prediction and a device for implementing the same and, more specifically, a method of requesting use of a POI to automatically realize a use-of-POI waiting request at an optimal time point in consideration of a predicted waiting time based on a waiting-for-use pattern of customers who visit the POI and a travel time to the POI, and a device for implementing the same.

### (b) Description of the Related Art

An electronic device may be configured to implement a navigation function configured to provide a route to a destination desired by a user on a map. Although the electronic device may be a portable device, such as a smartphone, the electronic device is not limited thereto and may be a product that is manufactured in various forms having similar software functions to portable devices. The product may be a means of transportation, for example, a vehicle (e.g., a car, truck, SUV, van, etc.).

A navigation function is not limited to basic route guidance but may have additional service functions accompanying the guidance to improve convenience for a user. Available services at spots related to a destination may be provided as additional services. Specifically, available services may support various processes, such as requests, reservations, and the like, related to the use of stores associated with a destination through an application of electronic devices. For example, when the desired destination is a store, and the store is a restaurant, a user may immediately use the restaurant via a request of use of the application or may not immediately use the restaurant but wait. The application may provide a service of making a request of use through waiting or a reservation when immediate use is not possible.

Such a service may be implemented using a so-called store waiting application, and a waiting application may be configured to present a user with a queue order and a predicted waiting time in response to a waiting-based request of use. Existing predicted waiting times are calculated using a method in which a waiting time per customer or group is arbitrarily input by a store.

According to the arbitrary input method, when the input waiting time does not correspond to an actual situation, the reliability of predictions may be degraded. This may result in incorrect information being provided to customers and may also lead to dissatisfaction. Waiting times may be recorded inaccurately due to an in-store input error or subjective judgment, which may degrade the consistency of a service.

When an actual waiting time is shorter than a predicted waiting time which is in error, a user who relies on the prediction in error to drive to the store may be reordered to the back of the queue, or the user's request of use may even be canceled, and the user may not be able to use the store. In addition, a case where a user first checks a predicted waiting time to use a store and then separately requests waiting for use in accordance with a time of arrival by vehicle may cause inconvenience while the user is driving.

### SUMMARY

The technical object of the present disclosure is directed to providing a method of requesting use of a point of interest (POI) to automatically realize a use-of-POI waiting request at an optimal time point in consideration of a predicted waiting time based on a waiting-for-use pattern of customers who visit the POI and a movement time to the POI, and a device for implementing the same.

Technical objects to be achieved by the present disclosure are not limited to that described above, and other technical objects that have not been described will be clearly understood by those skilled in the technical field to which the present disclosure pertains from the following description.

According to the present disclosure, there is provided a method of requesting use of a point of interest (POI) using waiting time prediction. The method may comprise: using an electronic device, comprising a processor and a memory: generating an expected arrival time for a destination designated by a user in response to determining that the destination is a spot available for a request; estimating a waiting time for using the destination based on waiting information comprising a waiting-for-use pattern of the spot; estimating an expected time of use for the spot based on the waiting time of the spot; requesting use of the spot to generate a request for use in response to the expected arrival time being the expected time of use or earlier; and providing a route to the spot in response to an approval for the request of use.

According to an exemplary embodiment of the present disclosure in the method, the waiting information may comprise actual waiting time information cumulatively collected from at least one of a spot management server associated with the spot and a user device.

According to an exemplary embodiment of the present disclosure in the method, the waiting-for-use pattern may comprise a waiting time distribution based on actual waiting times accumulated from the spot that the user plans to use, and one or more other spots for one or more time periods.

According to an exemplary embodiment of the present disclosure in the method, the spot is a spot that has: a waiting frequency of a threshold frequency or more; and a waiting time exceeding a maximum time during a predetermined period.

According to an exemplary embodiment of the present disclosure in the method, the waiting-for-use pattern may comprises a waiting time distribution based on actual waiting times of a plurality of spots having a similarity between spot information of the spots, and the spot information may comprise at least one of: a type of spot; operational information of the spot; one or more items provided at the spot; a size of the spot; a customer accommodation capacity of the spot; and a rating of the spot.

According to an exemplary embodiment of the present disclosure in the method, the waiting information may be based on current waiting people number information of the spot and actual waiting time information.

According to an exemplary embodiment of the present disclosure in the method, the waiting-for-use pattern of the spot may be cumulatively generated in time series, the waiting time may be predicted by a waiting time prediction model, the waiting time prediction model may be configured to employ a weighted sum of a time-series average waiting-for-use pattern or machine learning, and the machine learning may be configured to utilize the time-series average waiting-for-use pattern as an input.

According to an exemplary embodiment of the present disclosure in the method, when movement to the spot involves a vehicle and a walk, and the vehicle and the walk each have required times of travel: the expected arrival time may be generated by adding both required times of the vehicle and the walk, and the expected time of use may be generated by adding the required time of the walk and the waiting time.

According to an exemplary embodiment of the present disclosure in the method, the method may comprise: providing a route to the spot in response to the expected arrival time exceeding the expected time of use; updating the expected arrival time based on traffic information, to generate an updated expected arrival time; and requesting the use of the spot in response to the updated expected arrival time being the expected time of use or earlier.

According to an exemplary embodiment of the present disclosure in the method, the requesting of the use of the spot may be performed in response to a current time becoming a request-of-use time corresponding to the expected time of use during movement of the user. According to the present disclosure, there is provided an electronic apparatus for requesting use of a point of interest (POI) using waiting time prediction, the electronic apparatus comprising: a communication unit configured to transmit and receive data to and from an external device; a memory configured to store at least one instruction; and a processor configured to execute the at least one instruction stored in the memory, wherein the at least one instruction, when executed by the processor, is configured cause the processor to: generate an expected arrival time for a destination designated by a user in response to determining that the destination is a spot available for a request, estimate a waiting time for using the destination based on waiting information comprising a waiting-for-use pattern of the spot; estimate an expected time of use for the spot based on a waiting time of the spot; control the electronic apparatus or a user device to request use of the spot to generate a request for use in response to the expected arrival time being the expected time of use or earlier, and provide a route to the spot in response to an approval for the request of use.

According to the present disclosure, it is possible to provide a method of requesting use of a POI to automatically realize a use-of-POI waiting request at an optimal time point in consideration of a predicted waiting time based on a waiting-for-use pattern of customers who visit the POI and a movement time to the POI, and a device for implementing the same.

Effects that can be obtained from the present disclosure are not limited to that described above, and other effects that have not been described will be clearly understood by those skilled in the technical field to which the present disclosure pertains from the following description.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a diagram illustrating a vehicle communicating with other devices to transmit and receive data, according to an exemplary embodiment of the present disclosure.

FIG. 2 is a diagram illustrating modules constituting a vehicle, according to an exemplary embodiment of the present disclosure.

FIG. 3 is a diagram illustrating modules constituting an electronic apparatus, according to an exemplary embodiment of the present disclosure.

FIG. 4 is a diagram illustrating functional modules of a processor and a memory of an electronic apparatus, according to an exemplary embodiment of the present disclosure.

FIG. 5 is a flowchart of a method of requesting use of a point of interest (POI) using waiting time prediction, according to an exemplary embodiment of the present disclosure.

FIGS. 6A and 6B are diagrams illustrating waiting information of a spot, according to an exemplary embodiment of the present disclosure.

### DETAILED DESCRIPTION

Hereinafter, the exemplary embodiment of the present disclosure will be described in detail. This exemplary embodiment is implemented based on the technical solution of the present disclosure, and shows a specific implementation method and a specific operation process, but the protection scope of the present disclosure is not limited to the exemplary embodiment below.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Hereinafter, embodiments of the present disclosure will be described with reference to the accompanying drawings.

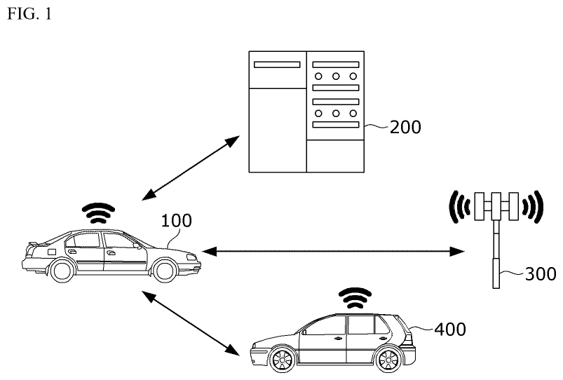

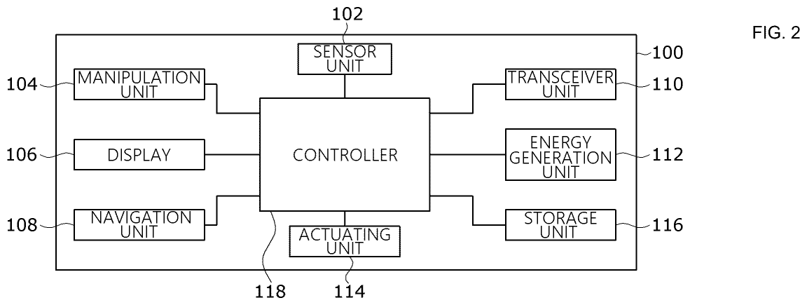

Referring to FIG. 1 and FIG. 2, an electronic device and a vehicle implementing a usage request for a point of interest using waiting time prediction will be described. FIG. 1 is a diagram illustrating a vehicle communicating with other devices to transmit and receive data, according to an exemplary embodiment of the present disclosure. FIG. 2 is a diagram illustrating modules constituting a vehicle, according to an exemplary embodiment of the present disclosure.

In the present disclosure, an electronic device is described as an example device configured to process route requests and usage requests for points of interest (POIs) received from the vehicle 100. The electronic device may comprise, e.g., a server 200 configured to implement a navigation function to process one or more requests from the vehicle 100 while communicating with the vehicle 100. Unlike the example described above, the electronic device may be configured to communicate with one or more other types of electronic devices besides the vehicle 100, and an electronic device such as a mobile terminal (e.g., a smartphone) may be configured to transmit route requests and usage requests for points of interest to the electronic device 200. The electronic device may be configured to process the requests from the mobile terminal. Accordingly, the matters described below are primarily explained with a focus on the processing of usage requests between the vehicle 100 and the electronic device 200 (server), but they may be substantially applied to a mobile terminal in the same manner.

Referring to FIG. 1, the vehicle 100 may be configured to be driven based on electric energy or fossil energy. In the case of electric energy, the vehicle 100 may be configured to adopt a pure battery-based vehicle driven solely by a high-voltage battery or a gas-based fuel cell as an energy source. The fuel cell may be configured to utilize various types of gases capable of generating electric energy, and the gas may be filled in the vehicle 100 in a liquefied state. For instance, the gas may be hydrogen, but various other gases may also be applicable. In the case of fossil energy, the vehicle 100 may be configured to be driven based on fuels such as gasoline, diesel, or liquefied gas, and it may be equipped with an internal combustion engine that drives an actuator 114 by burning the fuel. As another example, the vehicle 100 may comprise a hybrid type vehicle selectively utilizing the energy of a fossil fuel-based internal combustion engine and an electric battery to drive the actuating unit 114.

The vehicle 100 may refer to a movable device. The vehicle 100 may be a ground vehicle, such as a typical passenger or commercial vehicle, or a purpose-built vehicle (PBV) for specific purposes. The vehicle 100 may comprise a four-wheeled vehicle, such as a passenger car, SUV, or small truck, or a vehicle with more than four wheels, such as a bus, large truck, container carrier, or heavy equipment. The vehicle 100 may also be a robot in the broad sense of a movable means, and the robot may be configured to move using wheels, tracks, or other mobility modules.

The vehicle 100 may be configured to be controlled and driven autonomously, and autonomous driving may be implemented as semi-autonomous driving or fully autonomous driving.

Meanwhile, the vehicle 100 may be configured to perform communication with one or more other devices 200, 300, and/or other vehicles 400. The one or more other devices may comprise, for example, a server 200 configured to support various control state management functions and/or the driving of the vehicle 100, an Intelligent Transportation System (ITS) device 300 configured to receive information from ITS, and/or various other types of user devices. The server 200 may comprise an external device operated by a vehicle manufacturer or prepared to provide autonomous driving services and may be configured to transmit or receive connected data necessary for autonomous driving to or from the vehicle 100. The server 200 may be configured to transmit various information and software modules used for the control of the vehicle 100 in response to requests and data transmitted from the vehicle 100 and user devices to support autonomous driving and various services of the vehicle 100.

The server 200 may be configured to process a route request for a destination made by the vehicle 100 and also request use of a POI (or spot) associated with the destination. Here, the spot may provide a specific service desired by a user, and may be a restaurant, a café, a hair salon, a hospital, a convenience facility, an amusement facility, or the like. The server 200 may be configured to manage map information for processing the route request and various spot information related to the spot. The spot information may comprise, for example, at least one of a type of spot, operational information of the spot, items provided at the spot, a size of the spot, a customer accommodation capacity of the spot, and a rating of the spot.

The ITS device 300, for instance, may comprise a Road Side Unit (RSU). The ITS device 300 may be configured to exchange vehicle perception data, driving control and state data, environmental data around the vehicle, and map data with the vehicle 100 through Vehicle-to-Infrastructure (V2I) communication to assist the user's driving or support autonomous driving of the vehicle 100. The vehicle 100 may be configured to support manual or autonomous driving by exchanging the aforementioned data with other vehicles 400 through Vehicle-to-Vehicle (V2V) communication.

The vehicle 100 may be configured to perform communication with other vehicles or devices based on cellular communication, Wireless Access in Vehicular Environment (WAVE) communication, Dedicated Short Range Communication (DSRC), or other communication methods.

For instance, the vehicle 100 may be configured to use communication networks such as LTE or 5G, WiFi networks, or WAVE networks for communication with the server 200, ITS device 300, and other vehicles 400. In another example, DSRC used in the vehicle 100 may be utilized for inter-vehicle communication. The communication methods among the vehicle 100, the server 200, the ITS device 300, other vehicles 400, and user devices are not limited to the above-described embodiments.

FIG. 2 illustrates a diagram of modules constituting a vehicle, according to an exemplary embodiment of the present disclosure.

The vehicle 100 may comprise a sensor unit 102, a manipulation unit 104, a display 106, a navigation unit 108, and a transceiver unit 110.

The sensor unit 102 may be equipped with various types of detectors to sense various states and situations occurring in the external environment, internal system, user operations, and passenger space of the vehicle 100. The sensor unit 102 may comprise an external-facing camera, LIDAR sensor, radar sensor, and the like to recognize dynamic and static objects existing outside the vehicle 100. The sensor unit 102 may comprise a positioning sensor, wheel sensor, and attitude sensor to confirm its position, speed, and driving posture. A detection module for identifying various situations not listed above may be additionally included in the sensor unit 102.

The manipulation unit 104 may be configured as a module for user control for driving. For instance, the manipulation unit 104 may comprise a steering wheel for manual driving, an automatic or manual transmission actuator, an accelerator pedal, a brake pedal, a gearbox, etc. The manipulation unit 104 may further comprise an interface for the use/deactivation of the autonomous driving mode requested by the user and the selection of detailed function to utilize the autonomous driving function.

The display 106 may be configured to function as a user interface. The display 106 may be configured to display the operation state, control state, route/traffic information, remaining energy information, and contents requested by the driver of the vehicle 100 as controlled by the processor 122. The display 106 may also be configured to receive driver's requests instructing the processor 122 by being configured as a touch screen detecting driver input.

The navigation unit 108 may be configured to receive the user's route request for the destination to transmit the route request to the server 200 and may be configured to receive route information from the server 200 to provide the route information visually. The navigation unit 108 may be configured to be executed on the display 106 or implemented in a separate device installed in the vehicle 100. For example, the separate device may comprise a module uniquely installed in the vehicle 100 or the user's electronic device that is connected to the vehicle 100. The user's electronic device may be configured to be controlled to access the vehicle 100 and show the route request and the route information on the display 106.

The present disclosure primarily describes modules related to the present embodiment in FIG. 2, but the vehicle 100 may further comprise a load device in addition to the navigation unit 108. The load device may be configured to be mounted on the vehicle 100 and be a kind of electric device for non-driving use, excluding the driving power system such as the wheel driver. The load device may comprise an auxiliary device supplied with power from the energy generation unit 112, such as an air conditioning system, lighting system, seat system, and various devices installed in the vehicle 100.

The transceiver unit 110 may be configured to support mutual communication with the server 200, ITS device 300, and surrounding vehicles 400. The transceiver unit 110 may comprise one or more modules configured to handle cellular communication, WAVE, DSRC communication, etc. The transceiver unit 110 may also be configured to support communication with electronic devices carried by passengers inside the vehicle 100.

The vehicle 100 may comprise the energy generation unit 112 and the actuating unit 114.

The energy generator 110 may be configured to generate and supply power and electricity used in the driving power system, such as the actuating unit 118, and the non-driving power system. The non-driving power system may comprise, for example, the sensor unit 102, manipulation unit 104, display 106, load device, transceiver unit 110, and the like. When the vehicle 100 is driven based on electric energy, the energy generator 110 may be configured as an electric battery charged from an external source or a combination of an electric battery and a fuel cell charging the battery. When the vehicle 100 is driven based on fossil energy, the energy generator 110 may be configured as an internal combustion engine. Additionally, when the vehicle 100 is of a hybrid type, the energy generator 110 may be provided as a combination of an internal combustion engine and an electric battery.

The actuating unit 114 may comprise at least one module implementing driving operations and may be configured to perform at least one of longitudinal control, such as acceleration and deceleration, and lateral control, such as steering, based on user requests from the manipulation unit 104. To this end, the actuating unit 114 may comprise a plurality of wheels, a driving force generation module for generating driving force and applying it to the wheels or transmitting the driving force, a braking module for decelerating the driving of the wheels, and a steering module for realizing lateral control of the wheels, among others. When the vehicle 100 is driven based on electric energy, the driving force generation module may comprise a motor assembly, and the braking module may further comprise a regenerative braking function.

Also, the vehicle 100 may comprise a storage unit 116 and/or a controller 118.

The storage unit 116 may be configured to store one or more applications and/or various data for controlling the vehicle 100 and load an application or read or record data at a request of the controller 118. In the present disclosure, the storage unit 116 may comprise a software module, for example, a navigation application, configured for processing route guidance and a request for use of a spot.

The controller 118 may be configured to perform overall control of the vehicle 100. The controller 118 may be configured to execute an application stored in the storage unit 116 and instructions. The controller 118 may be configured to execute the navigation application to process the user's request. Specifically, the controller 118 may be configured to receive a route request and a use-of-spot request of the user of the vehicle 100 to transmit the requests to the server 200 and may provide a response of the server 200 processing the requests to the user.

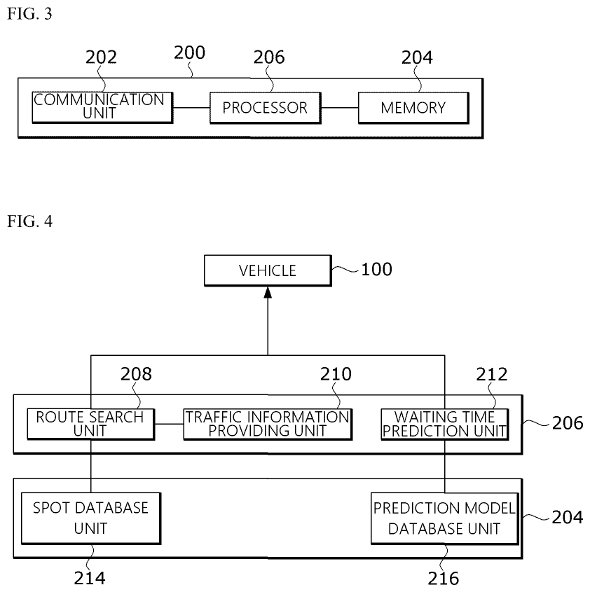

FIG. 3 illustrates a diagram of modules constituting an electronic apparatus, according to an exemplary embodiment of the present disclosure. In the present disclosure, an electronic apparatus that makes a use-of-POI request using waiting time prediction may be exemplified as the server 200 communicating with the vehicle 100.

As described above, the server 200 may be configured to perform a navigation function of processing requests related to route guidance and a use-of-spot request of the vehicle 100. The server 200 may comprise a communication unit 202, a memory 204, and a processor 206.

The communication unit 202 be configured to transmit and receive data to and from an external device. In the present disclosure, the communication unit 202 be configured to support intercommunication with the vehicle 100 and may be configured to exchange data with the vehicle 100.

The memory 204 may be configured to store applications and various data configured for running the server 200 and load an application or read or record data at a request of the processor 206. In the present disclosure, the memory 204 may comprise a software module, for example, a navigation application, for processing a request, for example, route guidance and a use-of-spot request, received from the vehicle 100. The memory 204 may be configured to manage map information for processing a route request and various spot information related to spots as a database.

The spot information may comprise, for example, at least one of one or more types of spots, operational information of spots, items provided at spots, sizes of spots, customer accommodation capacities of spots, and ratings of spots. The types of spots may comprise one or more types of services provided to a user. For example, the types may be classified as restaurant, hair salon, café, hospital, and the like, and the types may be types of services provided by convenience facilities or amusement facilities other than the foregoing examples. The operational information of spots may comprise, for example, operating hours of spots, whether reservations and waiting for use are possible, the presence or absence of a parking lot, the number of parking spaces allowed, and the like. The items provided at spots may comprise a detailed menu of services. For example, the items may comprise the menus of restaurants/cafés, detailed medical treatment departments of hospitals, and various menus offered by convenience facilities or amusement facilities. The sizes of spots may comprise, for example, the sizes of the corresponding facilities, the turnover rates of customers using the spots, and the like. The customer accommodation capacities of spots may include, for example, the maximum numbers of people who can visit the spots, the numbers of seats, the maximum numbers of people who can wait in line, and the like. The ratings of spots may comprise, for example, reputations for users using spots, and the ratings may be received from a management server of spots via, for example, the users' portable terminals, a social medium, or a web.

The processor 206 may be configured to perform overall control of the server 200. The server 200 may be configured to execute applications and instructions stored in the memory 204. The controller 118 may be configured to execute the navigation application to process a user's request. Specifically, the server 200 may be configured to receive a route guide request for a destination from the vehicle 100 and also receive or generate a request for the use of a destination-related spot at a request or estimation that the user is going to use a specific service at the destination. The spot that provides the specific service may be, for example, a place that the user visits to use the service. The spot may be a place that is reserved through a portable terminal or the vehicle 100 or a place of which use is reserved via a waiting request to use the place within as short time as possible after arrival. The spot provides the specific service desired by the user, and may be, for example, a restaurant, a café, a hair salon, a hospital, a convenience facility, an amusement facility, or the like.

When the destination set by the user is a spot of which waiting for use can be requested, the server 200 may be configured to execute a process of searching for a route to the destination on the basis of traffic information and generating an expected arrival time in accordance with a found route. In the example of FIG. 4, the process may be performed using a route search unit 208 and a traffic information providing unit 210. FIG. 4 illustrates a diagram showing functional modules of a processor and a memory of an electronic apparatus. The route search unit 208 may be configured to generate a planned route to the destination and an expected arrival time in accordance with the route using a shortest time, a shortest distance, a minimum cost, or an optimal combination thereof on the basis of traffic situations and map information provided in real time from traffic information. The traffic information providing unit 210 may be configured to receive traffic situation data including congestion, accident information, weather conditions, and the like on a road on which at least the vehicle 100 can travel, from an external server, another vehicle, or an external device and transmit the traffic situation data to the route search unit 208.

Also, the processor 206 may be configured to perform a process of predicting an expected time of using the spot on the basis of a waiting time of the spot based on waiting information including at least a waiting-for-use pattern at the spot. According to the example of FIG. 4, the process may be performed by a waiting time prediction unit 212. The waiting time prediction unit 212 may be configured to generate a waiting time on the basis of information accumulated by a prediction model database unit 216, for example, spot information and waiting information of the spot. The waiting time prediction unit 212 may comprise a waiting time prediction model embedded therein, and the model may predict an expected time of use on the basis of the waiting time. The waiting time prediction unit 212 may be configured to transmit the waiting time and the expected time of use to the vehicle 100 to check the availability of the spot, a time of using the spot, and the like. The expected time of use may be defined as a time in the form of hours, minutes, and seconds or as a required time which is identical to the waiting time. The prediction model database unit 216 may be configured to manage a waiting-for-use pattern analyzed from an actual past waiting time of the user as waiting information. In FIG. 4, the spot information may be managed by a spot database unit 214 of the memory 204.

When the expected arrival time is the expected time of use or less, the processor 206 may be configured to control the server 200 or the user's device (or user device) to request use of the spot. In FIG. 4, the route search unit 208 may be configured to transmit the request of use to a spot management server (not shown) that manages the spot. The present disclosure is not limited thereto, and another module of the processor 206 not shown in FIG. 4 may transmit the request of use. When the spot management server approves the request of use, the processor 206 may be configured to provide a route to the spot to the vehicle 100 using the route search unit 208. The processor 206 may be configured to transmit the waiting time and the expected time of use to the vehicle 100 at the same time as or a different time from provision of the route.

In the present disclosure, the processor 206 is illustrated as being configured as a single processing module in which a plurality of functional modules are embedded. As another example, the processor 206 may be distributed to a plurality of processing modules, and the above process may be performed by the distributed processing modules. As still another example, the functions of the sub-modules illustrated in FIG. 4 may be performed by each individual server, and the individual servers may be interconnected to organically process requests related to route guidance and a request of use.

For convenience of description, it is described below that the processor 206 may comprise the functional modules illustrated in FIG. 4, but a method according to the present embodiment may be realized through the other examples described above, distributed processing in the server 200 or processing through each individual server.

Processing of the server 200 having the above-described processor 206 will be described in detail with reference to FIGS. 1 to 6.

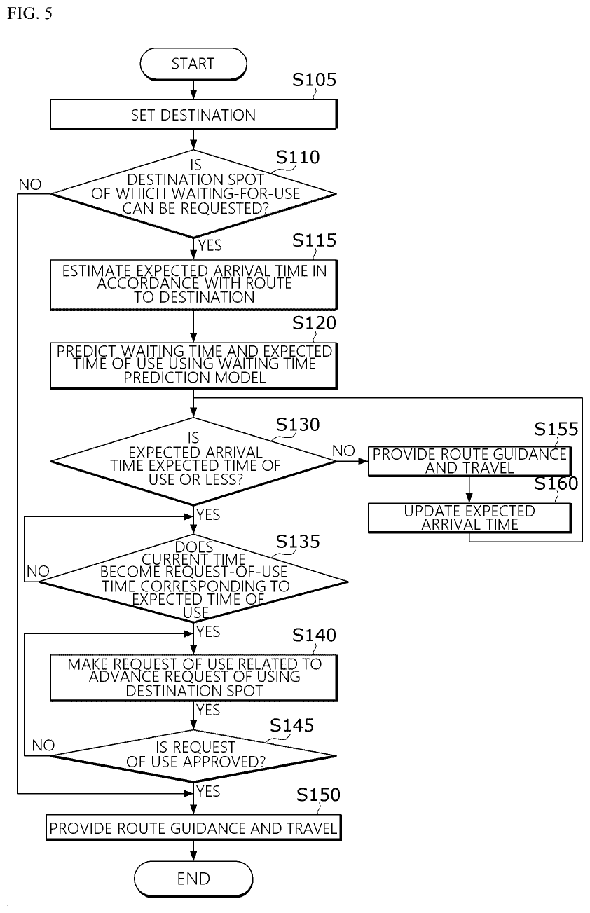

FIG. 5 illustrates a flowchart of a method of requesting use of a POI using waiting time prediction according to another embodiment of the present disclosure.

In the present disclosure, an electronic device that requests route guidance and use of a spot is illustrated as the vehicle 100, and an electronic apparatus that processes the request is illustrated as the server 200. Meanwhile, the processing may be performed by the detailed functional modules of FIG. 4 constituting the processor 206 and the memory 204, but for convenience of description, the processor 206 and the memory 204 may be interchangeably used with the detailed functional modules. Furthermore, the processor 206 and the controller 118 may be configured to be interchangeably used with the server 200 and the vehicle 100, respectively.

First, the vehicle 100 may identify a destination set by a user in response to a user request received via the navigation unit 108 and transmit a request message related to route guidance to the server 200, and the processor 206 of the server 200 may check map information and traffic information related to the destination (S105). The description below is based on the assumption that the destination is a spot that the user visits to receive a specific service rather than a simple spot of arrival. For convenience of description, a spot related to the destination may be illustrated as a restaurant. When the destination is a spot that supplies a specific service, the processor 206 may be configured to search for spot information along with the above-described information. Step S105 may be performed by the route search unit 208 of the processor 206.

The processor 206 of the server 200 may be configured to determine whether the destination is a spot of which waiting for use can be requested with reference to the spot information (S110). The spot information may be collected from, for example, spot management information and managed by the spot database unit 214 of the memory 204. The spot information may comprise various data, and the processor 206 may be configured to identify whether the spot related to the destination provides a service through waiting for use, using operational information of the spot among the data. When the spot is a restaurant, the operational information may comprise, for example, operating hours of the restaurant, the availability of the restaurant through a reservation, a request for waiting, and the like. Step S110 may be performed by the route search unit 208 of the processor 206.

When the destination is not a spot of which waiting for use is requested (NO in S110), the processor 206 may search for a route to the destination on the basis of map information and traffic information to generate route information and estimate an expected arrival time. Subsequently, the processor 206 may transmit the route information and the expected arrival time to the vehicle 100, and the vehicle 100 may control traveling in accordance with the guided route.

Unlike this, when the destination is a spot of which waiting for use is requested (YES in S110), the processor 206 may estimate an expected arrival time for the spot related to the destination on the basis of map information and traffic information (S115). When movement to the spot is substantially performed via the vehicle 100 only, the processor 206 may use a required time of the vehicle 100 for road travel as the expected arrival time. As another example, when movement to the spot involves the vehicle 100 and a walk, the expected arrival time may be generated by adding both required times of the vehicle 100 and the walk. When the user cannot arrive at the spot via travel of the vehicle 100 only, the route search unit 208 may generate route information including the travel route of the vehicle 100, a parking location of the vehicle 100 and an entire walk route from the parking location to the spot. The parking location may be a parking lot that is recommended by the route search unit 208 or specified by the user who checks expected routes. Here, the required time of the walk may be estimated on the basis of the walk route. Step S115 may be performed by the route search unit 208 of the processor 206.

Due to the waiting time prediction model, the processor 206 of the server 200 may predict a waiting time of the spot on the basis of waiting information at least including a waiting-for-use pattern of the spot and predict an expected time of using the spot on the basis of the waiting time (S120).

The waiting time prediction model may be embedded in the prediction model database unit 216, and the waiting time prediction unit 212 may be configured to execute the waiting time prediction model when step S120 is performed. A waiting time and an expected time of use may be generated by the waiting time prediction unit 212. The waiting information has various data collected from a spot management server and may be managed by the prediction model database unit 216.

The waiting information may comprise current waiting people number information of the spot that the user wants to use. The current waiting people number information may be primary data for estimating a waiting time. The waiting time may be calculated by multiplying the current waiting people number information by an approximate unit time. The approximate unit time is, for example, a time per customer who visits the spot and may be determined by a manager of the spot or a setting of the spot management server. A waiting time in accordance with the above-described process is calculated using a simple method in which a past waiting-for-use pattern is not taken into consideration, and thus the accuracy of predicting a waiting time may not be ensured.

To improve the prediction accuracy, the waiting information may further comprise actual past waiting time information accumulated from at least one of the spot management server associated with the spot and the user's device. The waiting time may be determined on the basis of an expected waiting time in accordance with the current waiting people number information and an expected waiting time in accordance with the actual past waiting time information. As another example, the waiting time may be determined on the basis of the actual past waiting time information without using the current waiting people number information. Actual waiting time information may have an actual waiting time of a user who already used, in the past, the spot that the user of the vehicle 100 wants to visit. The actual waiting time may be calculated by, for example, subtracting a time when the user requested waiting for use from a time when the user actually entered the spot. The actual waiting time information of the spot to be visited may be a waiting time distribution based on actual waiting times accumulated during each time period. For example, time periods may be separated by day of the week and time of day. Accordingly, the waiting time distribution may be generated as a waiting-for-use pattern that is accumulated in time series.

Further, to build the waiting information from sufficient actual waiting time information, the waiting information may also comprise actual past waiting time information of a plurality of other spots in addition to the spot to be visited by the user. Like the spot to be visited, actual past waiting time information of another spot may use, as a waiting-for-use pattern, a waiting time distribution of another spot based on actual waiting times accumulated during each time period. For the reliability of data, the other spot used for generating the waiting information may be a spot that has a waiting frequency having a threshold frequency or more and a waiting time having a maximum time or more during a predetermined period.

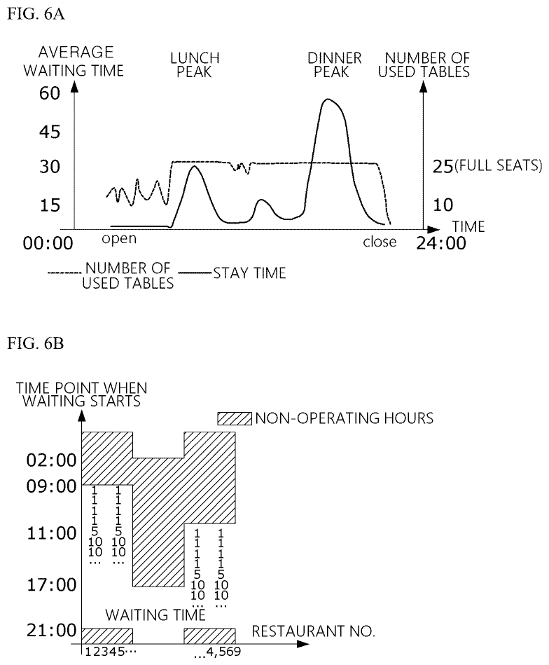

FIGS. 6A and 6B are diagrams illustrating waiting information of a spot. FIG. 6A shows waiting information having a waiting-for-use pattern in accordance with a time-series average waiting time of a spot, and the spot may be a spot that a user is planning to visit or visiting or may include another spot. FIG. 6A is an example based on the assumption that the spot is a restaurant, and statistically shows an average waiting time in accordance with a time period and the number of used tables in relation to a turnover rate. FIG. 6B is matrix data showing a distribution of actual time-series waiting times of all spots. FIG. 6B is also an example based on the assumption that the spots are restaurants, and shows, as a matrix distribution, actual waiting times of all the restaurants including a restaurant to be visited in accordance with a time period. For example, all the restaurants may not have a similarity with the restaurant to be used, or as another example, may be selected to have a similarity with the restaurant to be used. Various forms of statistical waiting-for-use patterns in waiting information may be acquired using the distribution of actual waiting times in FIG. 6B.

To improve the accuracy of predicting a waiting time of a spot to be used, waiting information may be generated using actual waiting times of a plurality of spots having a similarity between spot information of the spots. Waiting information of similar spots may also use a distribution of waiting times based on actual waiting times of each spot as a waiting-for-use pattern. Spot information used for similarity judgment may comprise, for example, at least one of a type of spot, operational information of the spot, items provided at the spot, the size of the spot, a customer accommodation capacity of the spot, and a rating of the spot. Details of the foregoing data constituting spot information are substantially the same as described above. For example, when a spot set by a user as a destination is a Chinese restaurant with 20 tables of which reservation/waiting for use is possible, data corresponding to a type, operational information, provided items, a size, a customer accommodation capacity, and a rating may be a restaurant, operating hours, reservation/waiting for use allowed, a Chinese menu, a turnover rate by time period, 20 to 30 tables, a good restaurant, and the like.

Due to the waiting time prediction model, the processor 206 may be configured to predict a waiting time of the spot on the basis of the waiting information. The waiting time prediction model may be configured to employ machine learning in which a weighted sum of time-series waiting-for-use patterns or the time-series waiting-for-use patterns are used as an input. A plurality of time-series waiting-for-use patterns may be provided, for example, in order of past time. A model based on a weighted sum may be constructed to give a higher weight when a past waiting-for-use pattern is closer to a time at which the user makes a request of use. The machine learning may be configured to employ time periods to which the time-series waiting-for-use patterns belong, number of waiting people, actual waiting time, and the like as training data to predict a waiting time when a request of use is made. The machine learning may comprise, for example, a recurrent neural network (RNN), a convolutional neural network (CNN) that processes a matrix related to past waiting times in waiting-for-use patterns as a heat map, a generative adversarial network (GAN) that generates a matrix having a predicted waiting time on the basis of past data, times of day, meteorological data, and the like belonging to the matrix, or the like. The above-described waiting time prediction model is mainly described using past waiting-for-use patterns, but as another example, at least one of current waiting people number information and an expected waiting time resulting from the current waiting people number information may be added as a variable of the prediction model to predict a waiting time.

The processor 206 may be configured to calculate an expected time of use in a visual form on the basis of the waiting time generated in units of required time. When movement to the spot is substantially performed via the vehicle 100 only, the processor 206 may be configured to calculate an expected time of use depending on the waiting time only. As another example, when movement to the spot involves the vehicle 100 and a walk, an expected time of use may be generated by adding the waiting time and a required time of the walk.

The processor 206 of the server 200 may be configured to determine whether the expected arrival time is the expected time of use or less (S130).

When the expected arrival time is the expected time of use or less, the processor 206 may be configured to determine whether a current time (or a time point) is a request-of-use time corresponding to the expected time of use (S135). Step S135 may be repeatedly performed until the current time becomes the request-of-use time.

When the current time becomes the request-of-use time, the processor 206 may be configured to control the server 200 or the user's device to automatically make a request of use related to an advance request of using the destination spot (S140). Steps S130 to S140 may be performed in an engine-on state in which the vehicle 100 is not traveling or a state in which the vehicle 100 is traveling to the spot. When the request of use is processed at a start point of the expected arrival time which is longer than the expected time of use, the user may need to enter the spot before arriving at the spot. To prevent the situation in which it is impossible to enter the spot after making the request, the request of use may be made at an optimal time by referring to the expected time of use. Further, while the vehicle 100 is traveling to transport the user, the request of use can be automatically processed without the user's manipulation such that the safety and convenience of travel can be improved.

The processor 206 may be configured to monitor an approval until it is confirmed that the request of use is approved by the spot management server (S145).

The processor 206 may be configured to generate route information of the destination spot of which use is requested on the basis of a route found in step S115 and transmit the route information to the vehicle 100, and the vehicle 100 may be configured to control its travel using the route information (S150). The route information may be transmitted, for example, after the request of use is approved, or as another example, after step S115.

Meanwhile, when the expected arrival time exceeds the expected time of use, the processor 206 of the server 200 may be configured to generate route information for the destination and the expected arrival time using the route search unit 208 and transmit the route information and the expected arrival time to the vehicle 100, and the vehicle 100 may be configured to control its travel in accordance with guidance from the route information (S155).

The processor 206 of the server 200 may be configured to update the expected arrival time on the basis of real-time traffic information using the route search unit 208 and transmit the updated expected arrival time to the vehicle 100 (S160). Also, the processor 206 proceeds to step S130 to determine whether the updated expected arrival time is the expected time of use or less and, when the expected arrival time is the expected time of use or less, may be configured to request use of the spot through steps S135 to S145.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method of requesting use of a point of interest (POI) using waiting time prediction, the method comprising:
using an electronic device, comprising a processor and a memory:
generating an expected arrival time for a destination designated by a user in response to determining that the destination is a spot available for a request;
estimating a waiting time for using the destination based on waiting information comprising a waiting-for-use pattern of the spot;
estimating an expected time of use for the spot based on the waiting time of the spot;
requesting use of the spot to generate a request for use in response to the expected arrival time being the expected time of use or earlier; and
providing a route to the spot in response to an approval for the request of use.

2. The method of claim 1, wherein the waiting information comprises actual waiting time information cumulatively collected from at least one of a spot management server associated with the spot and a user device.

3. The method of claim 2, wherein the waiting-for-use pattern comprises a waiting time distribution based on actual waiting times accumulated from the spot that the user plans to use, and one or more other spots for one or more time periods.

4. The method of claim 3, wherein the spot is a spot that has:
a waiting frequency of a threshold frequency or more; and
a waiting time exceeding a maximum time during a predetermined period.

5. The method of claim 2, wherein:
the waiting-for-use pattern comprises a waiting time distribution based on actual waiting times of a plurality of spots having a similarity between spot information of the spots, and
the spot information comprises at least one of:
a type of spot;
operational information of the spot;
one or more items provided at the spot;
a size of the spot;
a customer accommodation capacity of the spot; and
a rating of the spot.

6. The method of claim 2, wherein the waiting information is based on current waiting people number information of the spot and actual waiting time information.

7. The method of claim 1, wherein:
the waiting-for-use pattern of the spot is cumulatively generated in time series,
the waiting time is predicted by a waiting time prediction model,
the waiting time prediction model is configured to employ a weighted sum of a time-series average waiting-for-use pattern or machine learning, and
the machine learning is configured to utilize the time-series average waiting-for-use pattern as an input.

8. The method of claim 1, wherein, when movement to the spot involves a vehicle and a walk, and the vehicle and the walk each have required times of travel:
the expected arrival time is generated by adding both required times of the vehicle and the walk, and
the expected time of use is generated by adding the required time of the walk and the waiting time.

9. The method of claim 1, further comprising:
providing a route to the spot in response to the expected arrival time exceeding the expected time of use;
updating the expected arrival time based on traffic information to generate an updated expected arrival time; and
requesting the use of the spot in response to the updated expected arrival time being the expected time of use or earlier.

10. The method of claim 1, wherein the requesting of the use of the spot is performed in response to a current time becoming a request-of-use time corresponding to the expected time of use during movement of the user.

11. An electronic apparatus for requesting use of a point of interest (POI) using waiting time prediction, the electronic apparatus comprising:
a communication unit configured to transmit and receive data to and from an external device;
a memory configured to store at least one instruction; and
a processor configured to execute the at least one instruction stored in the memory,
wherein the at least one instruction, when executed by the processor, is configured cause the processor to:
generate an expected arrival time for a destination designated by a user in response to determining that the destination is a spot available for a request,
estimate a waiting time for using the destination based on waiting information comprising a waiting-for-use pattern of the spot;
estimate an expected time of use for the spot based on a waiting time of the spot;
control the electronic apparatus or a user device to request use of the spot to generate a request for use in response to the expected arrival time being the expected time of use or earlier, and
provide a route to the spot in response to an approval for the request of use.

12. The electronic apparatus of claim 11, wherein the waiting information comprises actual waiting time information cumulatively collected from at least one of a spot management server associated with the spot and the user device.

13. The electronic apparatus of claim 12, wherein the waiting-for-use pattern comprises a waiting time distribution based on actual waiting times accumulated from the spot that the user plans to use and one or more other spots for one or more time periods.

14. The electronic apparatus of claim 13, wherein the spot is a spot that has:
a waiting frequency of a threshold frequency or more, and
a waiting time exceeding a maximum time during a predetermined period.

15. The electronic apparatus of claim 12, wherein:
the waiting-for-use pattern comprises a waiting time distribution based on actual waiting times of a plurality of spots having a similarity between spot information of the spots, and
the spot information comprises at least one of:
a type of spot;
operational information of the spot;
one or more items provided at the spot;
a size of the spot;
a customer accommodation capacity of the spot; and
a rating of the spot.

16. The electronic apparatus of claim 12, wherein the waiting information is based on current waiting people number information of the spot and actual waiting time information.

17. The electronic apparatus of claim 11, wherein:
the waiting-for-use pattern of the spot is cumulatively generated in time series,
the waiting time is predicted by a waiting time prediction model,
the waiting time prediction model is configured to employ a weighted sum of a time-series average waiting-for-use pattern or machine learning, and
the machine learning utilizes the time-series average waiting-for-use pattern as an input.

18. The electronic apparatus of claim 11, wherein, when movement to the spot involves a vehicle and a walk, and the vehicle and the walk each have required times of travel:
the expected arrival time is generated by adding both required times of the vehicle and the walk, and
the expected time of use is generated by adding the required time of the walk and the waiting time.

19. The electronic apparatus of claim 11, wherein the at least one instruction, when executed by the processor, is further configured to cause the processor to:
provide a route to the spot in response to the expected arrival time exceeding the expected time of use;
update the expected arrival time based on traffic information to generate an updated expected arrival time; and
request the use of the spot through the electronic apparatus or the user device in response to the updated expected arrival time being the expected time of use or earlier.

20. The electronic apparatus of claim 11, wherein the request of the use of the spot is performed in response to a current time becoming a request-of-use time corresponding to the expected time of use during a movement of the user.
